(19) United States
(12) Patent Application Publication
(10) Pub. No.: US 2025/0139328 A1
(43) Pub. Date: May 1, 2025

(54) Manufacturing Information Estimation Device and Manufacturing Information Estimation Method

(71) Applicant: Hitachi, Ltd., Tokyo (JP)

(72) Inventors: Makoto ONODERA, Tokyo (JP); Kenji NISHIKAWA, Tokyo (JP); Ryogo HISHIKAWA, Tokyo (JP)

(21) Appl. No.: 18/897,095

(22) Filed: Sep. 26, 2024

(30) Foreign Application Priority Data
Oct. 25, 2023 (JP) 2023-183213

(51) Int. Cl. G06F 30/20; G06F 30/10

(52) U.S. Cl. CPC G06F 30/20; G06F 30/10

(57) ABSTRACT

Provided is a manufacturing information estimation device including a design and manufacturing related information storage section in which CAD model data, in which shape data and manufacturing attribute data of a product are recorded, and manufacturing process data, in which manufacturing process information for the CAD model data is recorded, are registered as design and manufacturing related information for each part, a similarity calculation section for calculating a similarity between a plurality of items of part data of design CAD model data to be subjected to manufacturing information estimation and registered part CAD model data, and calculating a partial similarity from both similarities of shape information and manufacturing attribute information, a similar part search section for searching the part CAD model data having the partial similarity equal to or greater than a threshold, a corresponding process information extraction section for extracting manufacturing process information corresponding to similar part CAD model data as corresponding process information, and a manufacturing process information generation section for combining the corresponding process information to generate estimated manufacturing process information corresponding to the design CAD model data.

### CLAIM OF PRIORITY

The present application claims priority from Japanese Patent application serial no. 2023-183213, filed on Oct. 25, 2023, the content of which is hereby incorporated by reference into this application.

### BACKGROUND OF THE INVENTION

### 1. Field of the Invention

The present invention relates to a technology for improving efficiency of defining and creating a Manufacturing Bill of Material (M-BOM) and a Bill of Process (BOP) in design and manufacture of a product, and in particular to a manufacturing information estimation device and a manufacturing information estimation method for estimating the M-BOM and BOP from Computer-Aided Design (CAD) data.

### 2. Description of Related Art

Evaluating a product design proposal in advance for manufacturability (ease of production), manufacturing costs, and environmental friendliness is an effective way to achieve Sustainable Development Goals (SDGs). For this reason, M-BOM and BOP information are required.

The M-BOM includes elements that are not included in design information, such as a material, a mold, a jig, and a lubricant, and the BOP includes information such as manufacturing procedures. However, creating M-BOM/BOP information (hereinafter referred to as manufacturing information) takes time and effort, so it is not necessarily easy to create and consider the above-described manufacturing information for each of a plurality of design proposals.

Therefore, efforts are reported to reduce a burden by reusing manufacturing information of a past product in a new product in reuse design.

In a recent year, an invention of this type has been disclosed in JP2013-254269A.

According to JP2013-254269A, a method efficiently extracts sub-assemblies similar to a newly designed sub-assembly from among sub-assemblies designed in the past, and makes it possible to reuse information about manufacturing processes of the past assemblies for the newly designed assembly, thereby making it easy and efficient to manage design and manufacturing of the assembly.

However, in order to evaluate manufacturability, manufacturing costs, and environmental friendliness in advance, it is necessary to take into consideration manufacturing information of an object to be designed in advance, but this is not taken into consideration in JP2013-254269A.

The invention is made in consideration of the above-described circumstance, and has an object to accurately estimate manufacturing information for a newly designed product by utilizing existing design information.

### SUMMARY OF THE INVENTION

In order to solve the above-described problem, a manufacturing information estimation device of the invention includes a design and manufacturing related information storage section in which CAD model data, in which shape data and manufacturing attribute data of a product are recorded, and manufacturing process data, in which manufacturing process information for the CAD model data is recorded, are registered as design and manufacturing related information for each part forming the product, a similarity calculation section for extracting a plurality of part design CAD model data from design CAD model data to be subjected to manufacturing information estimation, calculating a similarity in shape information and a similarity in manufacturing attribute information for each of part CAD model data registered in the design and manufacturing related information storage section, and calculating a partial similarity from the similarity in the shape information and the similarity in the manufacturing attribute information, a similar part search section for searching for the part CAD model data having a partial similarity equal to or greater than a threshold as similar part CAD model data, a corresponding process information extraction section for extracting the manufacturing process information corresponding to the similar part CAD model data as corresponding process information, and a manufacturing process information generation section for combining the corresponding process information to generate estimated manufacturing process information corresponding to the design CAD model data.

For a newly designed product, by searching existing design information for parts with similar partial shapes and manufacturing information, it is possible to estimate manufacturing information corresponding to entire new design information.

Problems, configurations and effects other than those described above will become apparent from the following description of embodiments.

### BRIEF DESCRIPTION OF THE DRAWINGS

FIG. 1A is an example of an overall configuration diagram of a manufacturing information estimation device;

FIG. 1B is an example of a functional block diagram of the manufacturing information estimation device;

FIG. 1C is an example of a processing flowchart of the manufacturing information estimation device;

FIG. 2A is an example of a CAD model registered in a design and manufacturing related information DB;

FIG. 2B is an example of the design and manufacturing related information DB;

FIG. 3 is an example of a target design CAD model;

FIG. 4 is an example of a processing result of a similar part search section;

FIG. 5 is an example of a processing result of a corresponding process information extraction section; and

FIG. 6 is an example of an estimated manufacturing process information DB as a processing result of a manufacturing process information generation section.

### DESCRIPTION OF EMBODIMENTS

An example of a manufacturing information estimation device of the present invention will be described below with reference to the drawings. An embodiment is an example for describing the present invention, and some omissions and simplifications are made as appropriate for clarity of description. The present invention can also be embodied in various other forms. Unless otherwise specified, each component may be singular or plural.

In order to facilitate understanding of the invention, the position, size, shape, range, and the like of each component illustrated in the drawings may not represent the actual position, size, shape, range, and the like. For this reason, the present invention is not necessarily limited to the position, size, shape, range, and the like disclosed in the drawings.

As examples of the various types of information, expressions such as “table” and “list” may be used, but the various types of information may be expressed in other data structures. For example, various types of information such as an “XX table” and an “XX list” may be expressed as “XX information”. When describing identification information, expressions such as “identification information”, “identifier”, “name”, “ID”, and “number” are used, but these are interchangeable.

When there are a plurality of components with the same or similar functions, they may be described using the same reference numerals with different subscripts. When there is no need to distinguish between these plurality of components, the subscripts may be omitted.

In the embodiment, a process performed by executing a program may be described. Here, a computer executes a program using a processor (for example, a CPU or a GPU), and performs a process defined by the program using a storage resource (for example, a memory) and an interface device (for example, a communication port). Therefore, a subject of the process performed by executing a program may be a processor. Similarly, the subject of the process performed by executing a program may be a controller, device, system, computer, or node having a processor. The subject of the process performed by executing a program may be a calculation unit, and may include a dedicated circuit that performs a specific process. Here, the dedicated circuit is, for example, a Field Programmable Gate Array (FPGA), an Application Specific Integrated Circuit (ASIC), or a Complex Programmable Logic Device (CPLD).

A program may be installed on a computer from a program source. The program source may be, for example, a program distribution server or a computer-readable storage medium. When the program source is a program distribution server, the program distribution server may include a processor and a storage resource that stores a program to be distributed, and the processor of the program distribution server may distribute the program to be distributed to other computers. In addition, in the embodiment, two or more programs may be realized as one program, or one program may be realized as two or more programs.

### First Embodiment

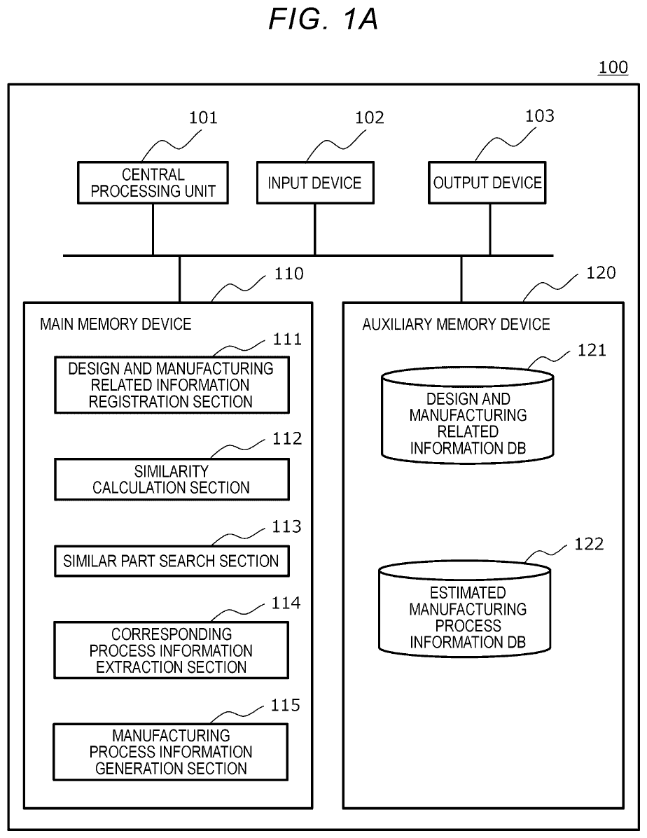

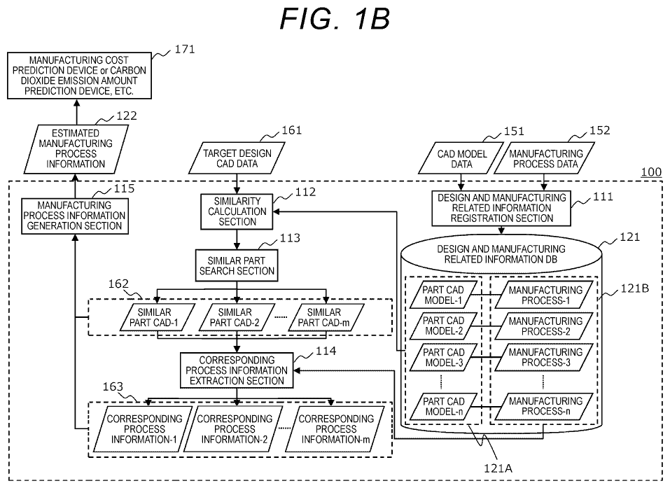

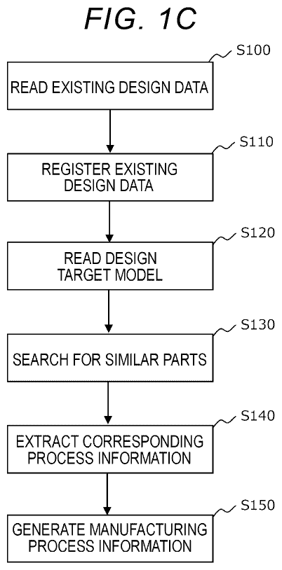

FIG. 1A is a block diagram of a manufacturing information estimation device 100 according to a first embodiment of the present invention, which is realized by a general computer and includes a central processing unit (CPU) 101 that performs a calculation process, an input device 102 such as a keyboard or a mouse, an output device 103 such as a display device, a main memory device 110, and an auxiliary memory device 120.

The main memory device 110 includes a design and manufacturing related information registration section 111, a similarity calculation section 112, a similar part search section 113, a corresponding process information extraction section 114, and a manufacturing process information generation section 115, which are all programs. Hereinafter, when a subject is described as “XX section”, it is assumed that the central processing unit 101 reads each program from the main memory device 110 and realizes a function (described in detail below) of each program on the main memory device.

The auxiliary memory device 120 has a design and manufacturing related information database (DB) 121 and a corresponding manufacturing process information DB 122. These databases may be provided outside the manufacturing information estimation device 100.

Next, details of each part and a processing operation of the manufacturing information estimation device 100 in this embodiment will be described with reference to FIG. 1B. FIG. 1B illustrates flow of data and processing in each part with arrows.

The design and manufacturing related information registration section 111 registers CAD model data 151 in which shape data and manufacturing attribute data of past products (here, “products” also includes “parts” that make up a certain product; the same applies hereinafter) are recorded, and manufacturing process data 152 in which manufacturing process information of the CAD model data 151 is recorded, in the design and manufacturing related information DB 121.

The CAD model data 151 is made up of a plurality of pieces of partial data that make up one entire past product, and these are registered in the design and manufacturing related information DB 121 so that they can be individually searched for and accessed as “part CAD model-1” to “part CAD model-n” (121B). Similarly, manufacturing process information is registered as “manufacturing process-1” to “manufacturing process-n” (121B) corresponding to “part CAD model-1” to “part CAD model-n” (121A).

In addition, since a CAD model of an entire product may be a part of another product, the entire product is also registered as a type of part CAD model (hereinafter, a “part” of a product includes the “whole” product). Also, depending on a situation, it is not necessary to register all parts.

Methods of expressing shape data include, but are not limited to, B-Reps expression and spatial lattice model expression. In addition, manufacturing attribute data is attribute information that is not expressed as a shape but is necessary during manufacturing, and is information related to dimensional tolerances, geometric tolerances, surface roughness, surface treatments (plating, painting, or the like), welding instructions, and other processing instructions.

Generally, this shape data and manufacturing attribute data are managed as CAD model data. In particular, manufacturing attribute data is managed together with the CAD model in formats such as 3D Annotated model (3DA) or Model Based Definition (MBD).

Furthermore, the manufacturing process data 152 is data in which the type of manufacturing process and associated information are recorded. For example, in the case of a process of drilling a countersink, the type assigned is “countersink drilling process”. If necessary, the drill diameter, feed speed, jig name, and the like may be added as associated information.

These registration processes are performed each time a past product is designed and its design information and manufacturing information are generated, and information on a plurality of past products is accumulated and built into a database of design and manufacturing related information. The registration process may be performed by a user using the input device 102 to perform registration, or may be performed automatically via a communication line from an external device (not illustrated).

The similarity calculation section 112 extracts a plurality of part CAD model data that form a target design CAD model data 161, which is CAD model data of the product that is a target of manufacturing information estimation, calculates the similarity in terms of shape information and the similarity in terms of manufacturing attribute information for the extracted data with each part CAD model of a part CAD model group 121A registered in the design and manufacturing related information DB 121, and calculates partial similarity from the shape information similarity and manufacturing attribute information similarity.

The similarity of shape information can be calculated by known techniques, such as calculating the similarity using the area, perimeter, type of surface, curvature, and main direction length as geometric features and a connection relationship of surfaces as topological features (Prior literature: Makoto Onodera et al., “Development of an analysis model reuse type automatic mesh generation technology using similar sub-shape search”, Transactions of the Japan Society of Mechanical Engineers, Vol. 83, No. 853, 2017). In addition, there is a method of expressing the target shape in a voxel structure, defining blocks with several adjacent voxels, calculating the spectrum for each block, and calculating the similarity, but this is not limited thereto.

A manufacturing attribute information similarity Sm is calculated, for example, by Equation 1.

$${S}_{m} = \{ \begin{matrix}1. - \frac{{P}_{i} - {P}_{j}}{max ( {P}_{i} , {P}_{j} )} ; & When the attribute types of both are the same \\ 0.2 ; & When one of the attribute types is not specified \\ 1. ; & When neither attribute type is specified \\ 0. ; & When the attribute types of both are different\end{matrix} \qquad [ Equation 1 ]$$

Here, Pi is an attribute parameter (tolerance value or surface roughness) in the target design CAD model data 161, and Pj is an attribute parameter in the part CAD model group 121A.

In Equation 1, when both have the same attribute type (attribute type such as dimensional tolerance, surface finish, welding instructions, or the like), a difference in attribute parameter values (tolerance value, surface roughness, weld depth, and the like) is normalized, and the closer the value is to “1.0”, the more similar the values are.

Furthermore, when the attribute types of the two are different, the manufacturing attribute information similarity is set to “0.0”, but when the meanings of the attribute types are similar, this may be added as a separate calculation formula. For example, the geometric tolerances specified for surface finish and flat surfaces are nearly synonymous. In this case, the attribute types are considered to be the same, and the manufacturing attribute information similarity may be quantified from a difference between the tolerance value and surface roughness.

A partial similarity S is calculated from the calculated shape information similarity and manufacturing attribute information similarity. The partial similarity is calculated, for example, using Equation 2.

$$S = {w}_{s} {S}_{s} + {w}_{m} {S}_{m} \qquad [ Equation 2 ]$$

Here, ws is a weight of the shape similarity, Ss is shape similarity, wm is a weight of manufacturing attribute information similarity, and Sm is manufacturing attribute information similarity, and they have a relationship of “ws+wm=1.0”.

The similar part search section 113 searches for part CAD models of which the calculated partial similarity is equal to or greater than a predetermined threshold, and records them as similar part CAD model data 162 in, for example, the temporary memory area (not illustrated) of the main memory device 110. In this case, when a plurality of part CAD models of which the similarity is equal to or greater than the threshold are found, the one with the highest similarity may be selected, or all part CAD models of which the similarity is equal to or greater than the threshold may be displayed on the output device 103 along with their shape information and manufacturing attribute information for a user to select. In addition, even when no part CAD models of which the similarity is equal to or greater than the threshold are found, the user may be allowed to select part CAD models of which the similarity is equal to or greater than a predetermined similarity.

The threshold may be set to a predetermined value in advance, or may be interactively set by the user via a user interface using the input device 102 and the output device 103. Furthermore, two types of thresholds may be set, one for shape similarity and one for manufacturing attribute information similarity.

In this way, the user can select an appropriate part CAD model depending on a search situation or the user can adjust the threshold. Therefore, even when the threshold value set in advance is not appropriate (for example, when it is set too strict or vice versa), a valid part CAD model can be extracted.

The corresponding process information extraction section 114 extracts manufacturing process information corresponding to the similar part CAD model data 162 searched for by the similar part search section 113 from a part manufacturing process group 121B of the design and manufacturing related information DB 121, and records it as corresponding process information 163 in a temporary memory area (not illustrated) of the main memory device 110. As a result of the search by the similar part search section 113, a plurality of candidates of the similar part CAD model data 162 and their corresponding manufacturing process information and similarity may be displayed on the output device 103, and the user may select the manufacturing process information to be applied.

The manufacturing process information generation section 115 combines a plurality of pieces of corresponding process information 163 to create estimated manufacturing process information corresponding to the target design CAD model data 161, and stores this in the estimated manufacturing process information DB 122.

In addition, the created corresponding manufacturing process information is used as source data for predictions by a manufacturing cost prediction device, a carbon dioxide emission prediction device, or the like (171).

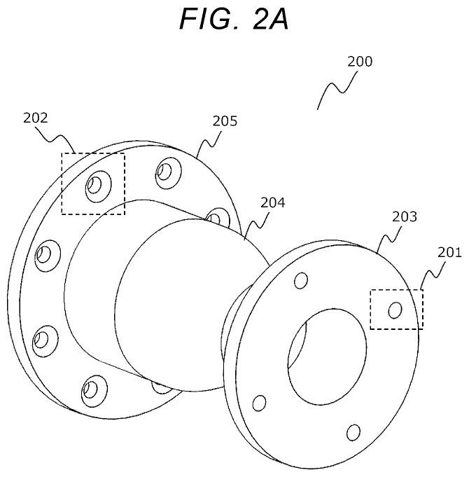

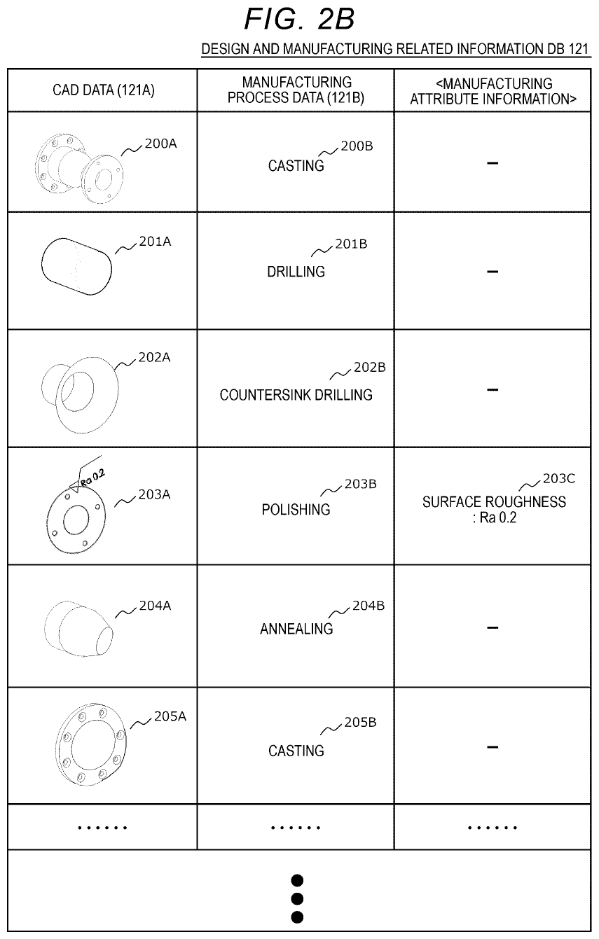

Next, an overall process flow will be described using a flowchart illustrated in FIG. 1C and examples of design parts illustrated in FIG. 2A and subsequent figures.

In step S100 of FIG. 1C, the manufacturing information estimation device 100 reads in the CAD model data 151 and its manufacturing process data 152 as existing design data. The CAD model data read in here is, for example, a reducer part 200 illustrated in FIG. 2A, which is composed of a first disk portion 203 and a second disk portion 205 that pinch a body portion 204. The first disk portion 203 has a plurality of holes 201 formed therein, and the second disk portion 205 has a plurality of countersinks and holes 202 connected thereto. The manufacturing process data 152 read in at the same time specifies the manufacturing process for each of these portions.

Next, in step S110, the design and manufacturing related information registration section 111 registers the CAD model data (part CAD model data) of each of the above-described portions and the manufacturing process data of the corresponding portions in the design and manufacturing related information DB 121. FIG. 2B is an example illustrating a state in which this data is registered in the design and manufacturing related information DB 121, in which, for the entire reducer part 200, “casting” 200B is registered as manufacturing process data corresponding to the overall CAD model data 200A.

Similarly, a hole 201A is designated as “drilling” 201B, a countersink 202A as “countersink drilling” 202B, and a plane 203A of the first disk portion 203 of which a surface finish is designated as precision finishing (arithmetic mean roughness (Ra)=0.2) as manufacturing attribute information 203C is associated with the manufacturing process of “polishing” 203B and registered in the design and manufacturing related information DB 121. Similarly, “annealing” 204B and “casting” 205B are registered for a body portion 204A and a second disk portion 205A.

That is, the CAD model data indicated by 200A to 205A are registered as the part CAD model group 121A in FIG. 1B, and the manufacturing process data indicated by 200B to 205B are registered as the manufacturing process information group 121B in FIG. 1B.

In addition, since the estimation accuracy of the manufacturing information estimation device 100 improves as the design information of related equipment and parts is registered comprehensively in the design and manufacturing related information DB 121, it is desirable to register as much data as possible. Therefore, it is desirable to repeatedly execute the registration process in steps S100 to S110 described above until there is no unregistered data.

Furthermore, these registration processes may be executed in the background independent of the estimation process described below each time design information of another device is received through a communication line, thereby expanding contents of the design and manufacturing related information DB 121. Also, the user may use the input device 102 to additionally register usable data. In that case, the registration process in steps S100 to S110 described above does not need to be executed each time the estimation process described below is executed.

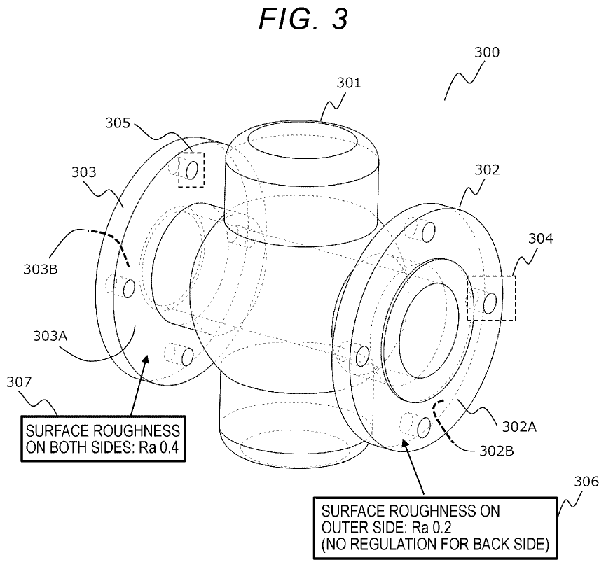

Next, in step S120, the CAD model data 161 of a design target model to be estimated is read. As an example of the design target model, a CAD model of a regulator part 300 illustrated in FIG. 3 will be described. The regulator part 300 has a first disk portion 302 and a second disk portion 303 that pinch a body portion 301, where the first disk portion 302 has a plurality of holes 304, and the second disk portion 303 also has a plurality of holes 305.

Furthermore, the manufacturing attribute information of the first disk portion 302 is given a surface roughness of “Ra 0.2” for an outer surface 302A, but not for an inner surface (back surface) 302B (reference number 306). The manufacturing attribute information of the second disk portion 303 is given a surface roughness of “Ra 0.4” for both surfaces (303A, 303B) (reference number 307).

Next, in step S130, for each part of the read design target model (regulator part 300), the similarity is calculated for each of the part CAD model group 121A and its manufacturing process information group 121B registered in the design and manufacturing related information DB 121, and a search is performed for parts of which the similarity is equal to or greater than a predetermined threshold. Here, the similarity is calculated using the above-described Equations 1 and 2, and the description will be given assuming that the weight (ws) of shape similarity and the weight (wm) of manufacturing attribute information similarity in Equation 2 are both “0.5”, and the threshold of partial similarity is “0.7”.

First, partial shapes of holes 303 and holes 304 completely match the holes 201A in the part CAD model in the design and manufacturing related information DB 121 illustrated in FIG. 2B, so the shape similarity for this is “1.0”. Furthermore, no manufacturing attribute information is assigned to the hole 303 and the hole 304, and the hole 201A, so the manufacturing attribute information similarity is also “1.0” from Equation 1. Therefore, the partial similarity is “1.0” from Equation 2.

Next, the partial shape of the first disk portion 302 completely matches the first disk portion 203A of the part CAD model in the design and manufacturing related information DB 121, so the shape similarity between the two is “1.0”. Furthermore, since the CAD model of the first disk portion 203A in the design and manufacturing related information DB 121 has the surface roughness in the surface finish specified as “Ra 0.2” as attribute information, the manufacturing attribute information similarity of the outer surface 302A of the first disk portion 302 is also “1.0”, and the partial similarity is also “1.0”.

On the other hand, for the inner surface 302B of the first disk portion 302, since no manufacturing attribute information is set, the manufacturing attribute information similarity is “0.2” and the partial similarity is “0.6”.

Similarly, since the partial shape of the second disk portion 303 completely matches the first disk portion 203A of the part CAD model in the design and manufacturing related information DB 121, the shape similarity between the two is “1.0”.

In addition, in the CAD model of the second disk portion 203A in the design and manufacturing related information DB 121, the surface roughness in the surface finish is specified as “Ra 0.2” as attribute information, so the manufacturing attribute information similarity of both surfaces (303A, 303B) of the second disk portion 303 is “0.5” and the partial similarity of both is “0.75”.

Similarly, for other portions such as the body portion 301 of the regulator part 300, matching with the design and manufacturing related information DB 121 is carried out to calculate the similarity of related portions, but detailed descriptions are omitted.

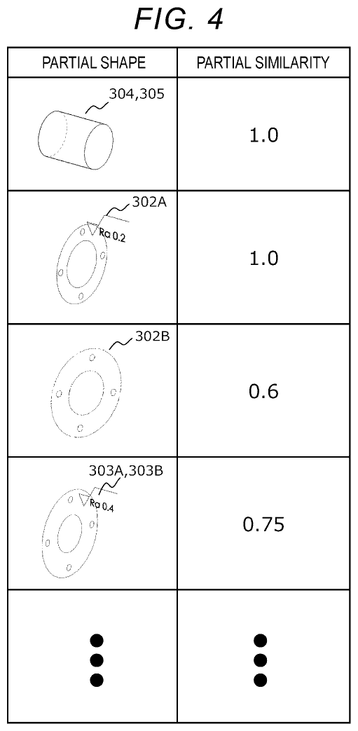

The partial similarity for each partial shape is summarized in FIG. 4. As such, the portions of which the partial similarity is equal to or greater than the threshold of “0.7” are the hole 303 and the hole 304, the outer surface 302A of the first disk portion 302, and both surfaces (303A, 303B) of the second disk portion 303, and these are recorded as search results, as the similar part CAD model data 162.

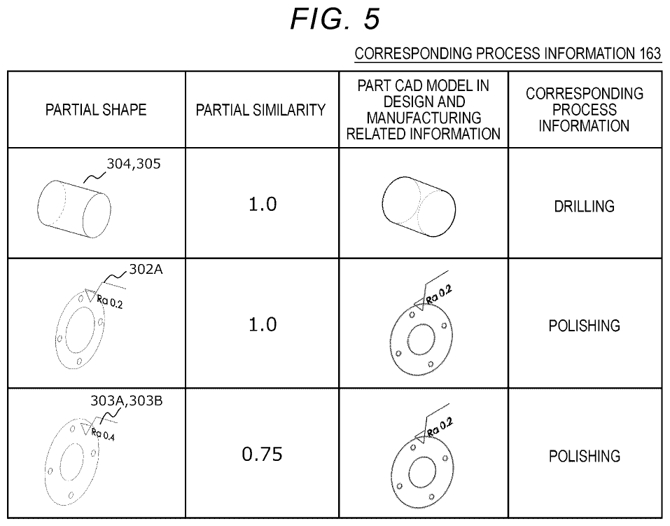

Next, in step S140, manufacturing process information corresponding to each of the similar part CAD model data 162 is extracted from the design and manufacturing related information DB 121 and recorded as the corresponding process information 163 as illustrated in FIG. 5.

The search results illustrated in FIG. 4 will be used as an example. The manufacturing process information corresponding to a similar part CAD 108 is extracted based on design and manufacturing related information 104 as illustrated in FIG. 5. The extracted manufacturing process information is registered as the corresponding process information 110.

Then, in step S150, the manufacturing process information generation section 115 combines each of the corresponding process information 163 to create estimated manufacturing process information DB 122 corresponding to the regulator part 300, which is the target design CAD model data 161.

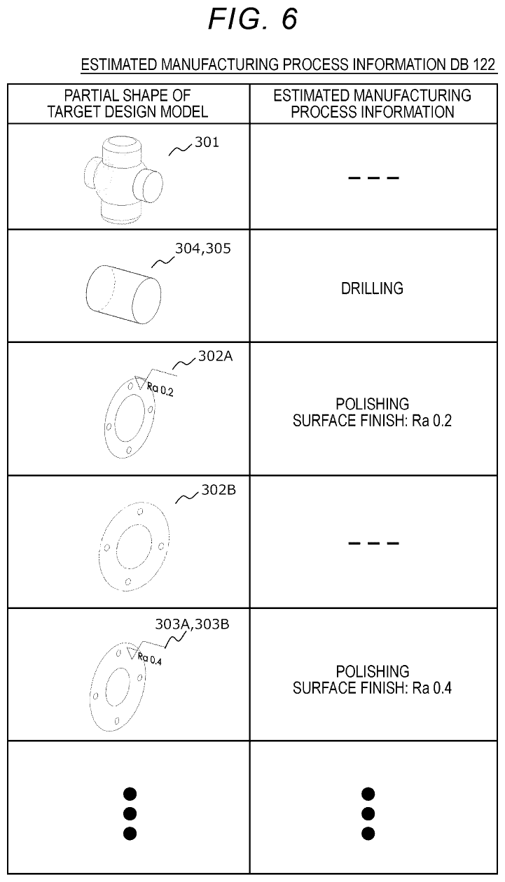

FIG. 6 illustrates an example, in which the process for the holes 304 and 305 is “drilling”, the process for the outer surface 302A of the disk portion 302 is “polishing” and “surface finish: Ra 0.2”, and the process for both surfaces (303A, 303B) of the second disk portion 303 is “polishing” and “surface finish: Ra 0.4”, which are registered in the estimated manufacturing process information DB 122.

Although no estimated manufacturing process information is obtained for the body portion 301 or the inner surface 302B of the disk portion 302, the user may add such deficient manufacturing process information using the input device 102, or the like.

In addition, the outer surface 302A of the disk portion 302 and both surfaces (303A, 303B) of the disk portion 303 are both assigned a polishing process, but since the specified surface roughnesses are different, it is expected that different abrasives will be used for the two.

In this case, the user can specify or edit the abrasives to be used for both portions based on past experience, or the like. In this way, it is possible to improve the accuracy of the estimation. In addition, by registering in advance in the design and manufacturing related information DB 121 the abrasives to be used depending on a level of surface finish, it is possible to reduce the number of items that the user needs to specify or edit.

As described above, according to this embodiment, by searching for parts of a newly designed object that have similar partial shapes and manufacturing information from existing design information, it is possible to estimate manufacturing information that corresponds to the entire new design information.

What is claimed is:

1. A manufacturing information estimation device, comprising:
a design and manufacturing related information storage section in which CAD model data, in which shape data and manufacturing attribute data of a product are recorded, and manufacturing process data, in which manufacturing process information for the CAD model data is recorded, are registered as design and manufacturing related information for each part forming the product;
a similarity calculation section for extracting a plurality of part design CAD model data from design CAD model data to be subjected to manufacturing information estimation, calculating a similarity in shape information and a similarity in manufacturing attribute information for each of part CAD model data registered in the design and manufacturing related information storage section, and calculating a partial similarity from the similarity in the shape information and the similarity in the manufacturing attribute information;
a similar part search section for searching for the part CAD model data having a partial similarity equal to or greater than a threshold as similar part CAD model data;
a corresponding process information extraction section for extracting the manufacturing process information corresponding to the similar part CAD model data as corresponding process information; and
a manufacturing process information generation section for combining the corresponding process information to generate estimated manufacturing process information corresponding to the design CAD model data.

2. The manufacturing information estimation device according to claim 1, wherein
a design and manufacturing related information registration section that registers the design and manufacturing related information in the design and manufacturing related information storage section.

3. The manufacturing information estimation device according to claim 2, wherein
the design and manufacturing related information registration section accepts a registration process by a user operating an input device or an automatic registration process from an external device via a communication line.

4. The manufacturing information estimation device according to claim 2, wherein
when a plurality of the part CAD model data having the partial similarity equal to or greater than the threshold are searched, the similar part search section selects a datum having a highest similarity, or displays the shape information and the manufacturing attribute information of the part CAD model data having the partial similarity equal to or greater than the threshold on an output device, and allows a user to select one.

5. The manufacturing information estimation device according to claim 4, wherein
the threshold used in the similar part search section is set to two types of thresholds including a similarity in the shape information and a similarity in the manufacturing attribute information.

6. The manufacturing information estimation device according to claim 5, wherein
the manufacturing process information generation section is capable of accepting an additional process by a user when there is a deficiency in the estimated manufacturing process information.

7. A manufacturing information estimation method, comprising:
registering CAD model data, in which shape data and manufacturing attribute data of a product are recorded, and manufacturing process data, in which manufacturing process information for the CAD model data is recorded, as design and manufacturing related information for each part forming the product;
extracting a plurality of part design CAD model data from design CAD model data to be subjected to manufacturing information estimation, calculating a similarity in shape information and a similarity in manufacturing attribute information for each of part CAD model data registered as the design and manufacturing related information, and calculating a partial similarity from the similarity in the shape information and the similarity in the manufacturing attribute information;
searching for the part CAD model data having the partial similarity equal to or greater than a threshold as similar part CAD model data;
extracting the manufacturing process information corresponding to the similar part CAD model data as corresponding process information; and
combining the corresponding process information to generate estimated manufacturing process information corresponding to the design CAD model data.
